(19) United States
(12) Patent Application Publication
(10) Pub. No.: US 2011/0032790 A1
(43) Pub. Date: Feb. 10, 2011

(54) VENTURI-EFFECT MODULAR MIXER

(76) Inventor: Adolfo CRISTANINI, Sant' Ambrogio di Valpolicella (IT)

Correspondence Address: BIRCH STEWART KOLASCH & BIRCH, PO BOX 747, FALLS CHURCH, VA, 22040-0747, US

(21) Appl. No.: 12/850,663

(22) Filed: Aug. 5, 2010

(30) Foreign Application Priority Data
Aug. 6, 2009 (IT) VI2009A000212

(51) Int. Cl. B01F 15/02

(52) U.S. Cl. 366/163.2

(57) ABSTRACT

A Venturi-effect mixer for mixing a working fluid with at least one decontamination/detoxification product. The mixer (1) comprises a box-like support structure (2) with a first module (20) which includes an inlet duct (3) for the working fluid, a second module (21) which includes mixing ducts (6, 6′) connected each other in parallel for mixing the working fluid with at least one decontamination/detoxification product and a third module (22) which includes an outlet duct (5) for the mixed fluid. The second module (21) is removably connected to the first module (20) and/or to the third module (22).

### FIELD OF INVENTION

The present invention generally relates to the technical field of the accessories for the decontamination/detoxification, and particularly concerns a Venturi-effect modular mixer.

### BACKGROUND OF THE INVENTION

Venturi-effect mixers are known which generally include a box-like support structure having an inlet duct for a working fluid, mixing means for mixing the latter with a decontamining/detoxifying product and an exit for the fluid so mixed.

From British patent application GB-A-2311333 is known a mixer in which the mixing means include two mixing ducts connected in parallel. Each mixing duct includes, in a substantially central position, a respective Venturi nozzle.

In this known mixer the box-like support structure is made of one piece, in such a manner that it is difficult or even impossible the access by an operator to the Venturi nozzles for cleaning, maintenance and/or removal of any impurities and/or dirt that prevent a correct mixing, with consequent lowering of the reclaiming efficacy.

The difficulty of access to these elements can be particularly dramatic in emergency situations, in which a lack of effective reclaiming can cause irreparable damages to persons or goods.

### SUMMARY OF THE INVENTION

Main object of the present invention is to at least partly overcome the above drawbacks, by providing a high efficient and relatively cost-effective Venturi-effect mixer.

Another object of the invention is to provide a Venturi-effect mixer that allows drawing two or more decontamination/detoxification products at the same time, by maintaining unaltered the mass flow of the working fluid.

Another object of the invention is to provide a Venturi-effect mixer that allows an easy and quick maintenance, clean and/or removal of impurities and/or dirt from the internal ducts.

Another object of the invention is to provide a Venturi-effect mixer that allows maintaining unaltered with time the reclaiming effectiveness.

Another object of the invention is to provide a Venturi-effect mixer that allows easily controlling the rate of product drawn and conveyed in the working fluid, by also allowing quickly varying the same.

These objects, as well as others that will appear more clear hereinafter, are achieved by a Venturi-effect mixer including a support box-like structure, which has an inlet duct for the working fluid, which can be e.g. water under pressure, Venturi-effect mixing means for mixing the working fluid with one or more decontamination/detoxification products, and an outlet duct for the mixed fluid.

The Venturi-effect mixing means include two or more mixing ducts, each comprising a respective Venturi nozzle having an inlet fluidically connected to the inlet duct, an outlet fluidically connected to the outlet duct and a respective convergence throat fluidically connectable with supplying means of at least one decontamination/detoxification product, contained in a separate container.

Suitably, the mixing ducts will be connected each other in parallel.

Thanks to this embodiment, the Venturi-effect mixer has high efficiency, while allowing drawing at the same time two or more decontamination/detoxification products, with high density and relatively high proportion (up to 20%), by maintaining unaltered the mass flow of the working fluid.

The box-like support structure will be of the modular type, with a first module which includes the inlet duct, a second module which includes the mixing ducts and a third module which includes the outlet duct.

The second module will be removably connected to the first and/or third module by a suitable removable fastening element, preferably of the bolt type.

Thanks to this embodiment, the access to the internal ducts of the mixer will be very quick and simple, in such a manner to facilitate the relative maintenance, repairs or the like.

The removal from the ducts, and in particular from the Venturi nozzles, of the impurities and/or dirt that prevent a correct mixing will be extremely fast and easy, which in emergency situations may mean saving many human lives.

Advantageous embodiments of the invention are defined in accordance with the dependent claims.

### BRIEF DESCRIPTION OF THE DRAWINGS

Further characteristics and advantages of the invention will be more apparent upon reading of the detailed description of a preferred, non-exclusive embodiment of a Venturi-effect mixer according to the invention, which is described as a non-limiting example with the help of the annexed drawings, in which:

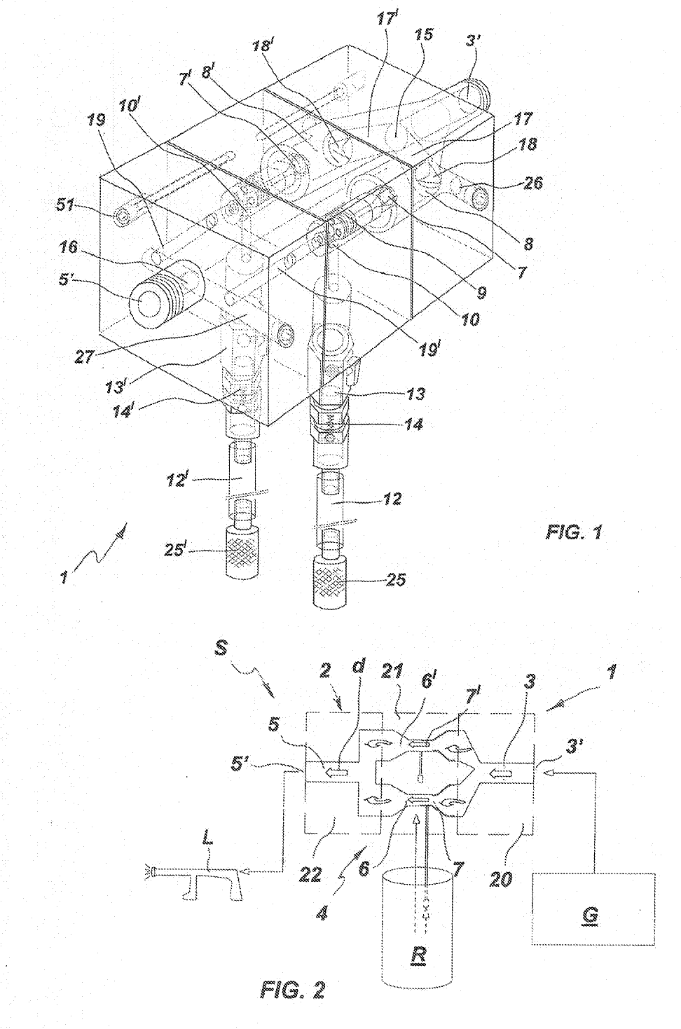

the FIG. 1 is a schematic axonometric view of an exemplary embodiment of the mixer 1;

the FIG. 2 is a schematic view of a system for reclaiming areas polluted by toxic or pathogenic chemical, bacteriological, nuclear and/or radiological agents that includes the mixer 1;

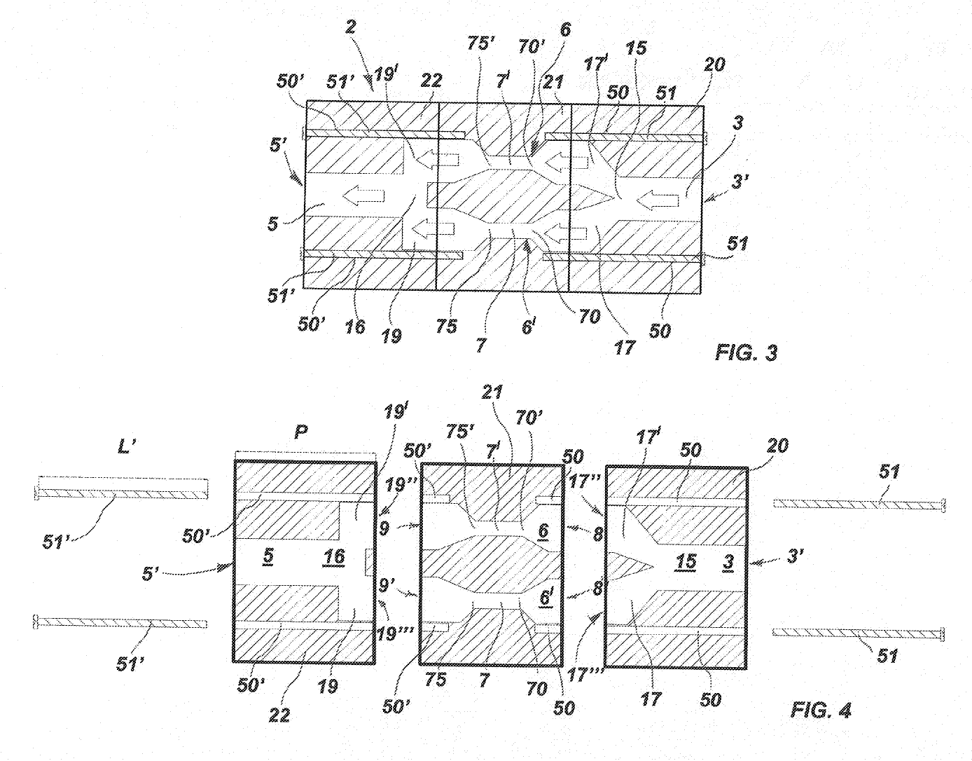

the FIGS. 3 and 4 are schematic views of an exemplary embodiment of the mixer 1, respectively in an exploded and assembled configuration.

### DETAILED DESCRIPTION OF A PREFERRED EMBODIMENT

As particularly shown in FIG. 2, the Venturi-effect mixer 1 may be an integral part of a system S for reclaiming/decontamining areas polluted by toxic or pathogenic chemical, bacteriological, nuclear and/or radiological agents.

The system S may include, in its most basic form, a generator G of a working fluid, which can be pressurized water, such as the Sanijet® mod. C921 sold by Cristanini SpA®, a mixer 1 for mixing the working fluid with one or more decontamination/detoxification products contained in the container R, such as the decontamination/detoxifying product made in accordance with the teachings of the Italian patent application VI2006A000285, and a jet lance L for spraying the resulting mixture on the area to be reclaimed/decontaminated.

The mixer 1 includes, essentially, a generally box-like support structure 2 comprising with an inlet duct 3 with an inlet 3′ for the working fluid, Venturi-effect mixing means, generally indicated 4, for mixing the working fluid with at least one decontamination/detoxification product and an outlet duct 5 with an outlet 5′ for the fluid so mixed.ù

Apparently, the generator G can be fluidically connected to the inlet 3′ of the mixer 1, while the jet lance L may be fluidically connected to the outlet 5′.

The mixing means 4 comprise two mixing ducts, 6, 6′, with respective Venturi nozzles, indicated 7, 7′.

The mixing ducts 6, 6′ are connected each other in parallel. In this manner, through the two ducts 6, 6′ the same flow of working fluid passes.

In particular, the Venturi nozzles, indicated 7, 7′, may have the respective inlet 70, 70′ fluidically connected to the inlet duct 3, the respective outlets 75, 75′ fluidically connected to the outlet duct 5 and convergence throats 10, 10′ fluidically connected to the container R, e.g. by respective suction hoses 12, 12′ inserted therein, to draw the decontamination/detoxification product.

The suction hoses 12, 12′ may include means for regulating the flow of the latter.

Thanks to these means, it will be possible to easily control the rate of the decontamination/detoxification product to be mixed with the working fluid.

The means for regulating the flow of the decontamination/detoxification product can preferably include, for each suction hose 12, 12′, a regulating valve 13, 13′ for regulating the flow section thereof and a non-return valve 14, 14′ located upstream of the regulating valve 13, 13′.

The special position of these valves 13, 13′, closely upstream the convergence throat 10, 10′, makes them particularly suitable for emergency applications, wherein it is necessary to adapt the reclamation to the various needs as soon as possible.

The regulating valve 13, 13′ may include a scale for dosing the decontamination/detoxification product, not represented in the annexed figures because per se known.

The suction hoses 12, 12′ may be optically transparent, in such a manner to allow the visual inspection of the decontamination/detoxification product. In this manner it is possible e.g. promptly checking the finish of the product, in such a manner to quickly replace it.

Each hose 12, 12′ may also have a bottom filter 25, 25′, so as to prevent the entry of any impurities which may be in the container R.

The box-like support structure 2 of the mixer 1 consists of a first module 20 which includes the inlet duct 3, a second module 21 which includes the mixing ducts 6, 6′ and a third module 22 which includes the outlet duct 5.

The second module 21 is removably connected to the first module 20 and/or third module 22 by at least one suitable removable fastening element, so as to facilitate the access by an operator to the inlet duct 3 and/or to the mixing ducts 6, 6′ and/or to the outlet duct 5.

It is understood that this removable connection may be by any removable fastening element without departing from the scope of protection defined by the terms of the appended claims.

However, in a preferred but non-exclusive embodiment, this removable fastening element may be of the bolt type.

It is also understood that the second module 21 can be removably connected to both the first module 20 and the third module 22, or even only to the first module 20 or only to the third module 22, without departing from the scope of protection defined by the terms of the appended claims.

Suitably, the removable fastening element of the bolt type may comprise at least one first internal thread 50 passing through the first module 20 and/or the third module 22 for the removable connection thereof to the second module 21 by a corresponding first bolt 51 bolted therein.

To this end, both the first internal thread 50 and the first bolt 51 must have an appropriate size.

For example, if the first module 20 and/or the third module 22 has a predetermined length P, taken along a direction parallel to the direction d of the flow through the inlet duct 3 and the outlet duct 5, the first internal thread 50 and the corresponding first bolt 51 has a length L greater than the length P.

In this manner, as particularly visible in FIG. 3, the first internal thread 50 and the first bolt 51 completely pass through the first module 20 and/or the third module 22, and partly through the second module 21.

If the second module 21 is removably connected to both the first module 20 and the third module 22, a second fastening element, having a second internal thread 50′ and a relative second bolt 51′ may be provided, substantially similar to the first one.

Advantageously, as particularly visible in the FIGS. 2 to 4, in the first module 20 the inlet duct 3 extends between the first inlet 3′ and a plurality of first outlets 17″, 17′″, in the second module 21 the mixing ducts 6, 6′ extend between a plurality of second inlets 8, 8′ and a plurality of second outlets 9, 9′ and in the third module 22 the outlet duct 5 extends between a plurality of third inlets 19″, 19″ and one third outlet 5′. These inlets and outlets will define also the inlets and outlets of the respective modules.

Suitably, the inlet duct 3 includes a single supplying node 15 fluidically connected to the first inlet 3′ for supplying the working fluid to a plurality of supply ducts 17, 17′ fluidically connected to said first outlets 17″, 17′″.

In order to minimize the pressure drop of the working fluid that reaches the inlet 70, 70′ of the Venturi nozzles 7, 7′, each of the supply ducts 17, 17′ may have a curve substantially greater than 90°, and preferably close to 135°, in correspondence of which a concave surface element 18, 18′ is inserted.

Suitably, each of the second inlets 8, 8′ may be fluidically connected to the respective first outlet 17″, 17′″ of said inlet duct 3 for the inlet of the working fluid in the respective Venturi nozzle 7, 7′.

On the other hand, each of the second outlets 9, 9′ may be fluidically connected to the third inlets 19″, 19′″ of the outlet duct 5 for conveying the mixed fluid.

Suitably, the outlet duct 5 may include a plurality of collecting pipes 19, 19′ fluidically connected to the third inlets 19″, 19′″ to collect the mixed fluid in a single collector node 16 fluidically connected to the third outlet 5′.

In order to maximize the turbulence of the mixed fluid, thus optimizing the mixing, each of the collector ducts 19, 19′ may have a substantially 90° curve.

Possibly, since in emergency situations it is necessary to always have the most effective reclaiming, means for controlling the pressure and/or the temperature of the working fluid and/or the mixed one may be provided.

To this end, the ducts 26 and 27, which are respectively fluidically connected to the second inlets 8, 8′ and the second outlets 9, 9′, may be provided with gauges and/or thermometers, not shown in the figures because they are per se known.

These gauges and/or thermometers may have a display easily visible from the outside by the operator, in such a manner to allow a quick action.

Operatively, the reclaiming system S works as follows.

At first, the inlet 3′ may be connected to the generator G, the outlet 5′ may be connected to the jet lance L and the suction hoses 12, 12′ may be inserted in the container R. At this point, it is necessary to act on the valves 13, 13′ to dosing the decontamination/detoxification product and acting on the lance L to spraying the mixed product to the area to be reclaimed.

The working fluid, generated by the generator G in a per se known manner, enters the first module 20, passing through the inlet 3, the node 15, the ducts 17, 17′ and then reaching the second module 21.

Here, the working fluid reaches the inlet 8, 8′ of the ducts 6, 6′, passing then into the Venturi nozzles 7, 7′ through the inlets 70, 70′. Since the supply ducts 17, 17′ are configured to minimize the pressure drop, the working fluid reaches the inlets 8, 8′ with substantially the same pressure, as well as substantially the same mass flow.

The passage of the working fluid through the Venturi nozzles 7, 7′ causes a vacuum that draws the decontamination/detoxification product from the container R by the suction hoses 12, 12′, passing through the valves 14, 14′ and 13, 13′ until the convergence throats 10, 10′, so as to mix it with the working fluid.

Thanks to the means for regulating the flow of the decontamination/detoxification product, it will be possible to instantaneously control this mixing, in such a manner to always have the most effective reclamation.

The parallel connection between the ducts 6, 6′, also allows the most effective suction of the decontamination/detoxification product, since the mass flow is substantially the same in both ducts.

The resulting mixture then passes through the outlets 9, 9′, reaching then the third module 22.

Here, the mixed fluid passes through the ducts 19, 19′ for collecting to the node 16. Thanks to the particular configuration of the latter, the working fluid continue to mix with the decontamination/detoxification product, so as to ensure the most reclamation efficiency.

From the node 16, the mixture reaches the outlet 5′, and then the nozzle L, so as to be sprayed on the area to be reclaimed/decontaminated.

The above disclosure clearly shows that the invention fulfills the intended objects.

The mixer according to the present invention is susceptible to a number of changes or variants, all within the scope of the invention disclosed in the appended claims. All the details thereof may be replaced by other technically equivalent parts, and the materials may vary depending on different needs, without departure from the scope of the invention.

For example, although in the above described exemplary embodiment the mixing ducts, 6, 6′ are two, it is understood that they will also be three or more. Apparently, in this case the number of components of the entire circuit is to be appropriately adjusted. Furthermore, although in the above exemplary embodiment the suction hoses 12, 12′ are both inserted in a single container R, it is understood that each hose can be inserted in a respective container, e.g. for sucking different decontamination/detoxification products.

What is claimed is:

1. A Venturi-effect mixer, comprising a box-like support structure with an inlet conduit for a working fluid, two or more mixing conduits connected each other in parallel for mixing the working fluid with one or more decontamination/detoxification products and an outlet conduit for the mixed fluid,
wherein each of said mixing conduits comprises a respective Venturi nozzle fluidically connected to said inlet conduit and said outlet conduit and having a convergence throat fluidically connectable to a container of the at least one decontamination/detoxification product,
wherein said box-like support structure consists of a first module which includes said inlet conduit, a second module which includes said mixing conduits and a third module which includes said outlet conduit,
wherein the mixer further comprises at least one first removable fastening element for removably connecting said second module and at least one of said first module and third module.

2. Mixer according to claim 1, wherein said at least one first removable fastening element is of the bolt type.

3. Mixer according to claim 2, wherein said at least one first removable fastening bolt element comprises at least one first internal thread passing through said at least one of said first module and third module for the removable connection thereof to said second module by a corresponding first bolt.

4. Mixer according to claim 3, wherein said at least one of said first module and third module extends along the direction of the flow passing through said inlet conduit and said outlet conduit for a predetermined length, said at least one first internal thread and the corresponding first bolt having a length greater than said predetermined length to completely pass through said at least one of said first module and third module and partly through said second module.

5. Mixer according to claim 1, wherein said first module includes one first inlet and a plurality of first outlets, said inlet conduit extending therebetween.

6. Mixer according to claim 5, wherein said inlet conduit includes a single supplying node fluidically connected to said first inlet for supplying the working fluid to a plurality of supply conduits fluidically connected to said first outlets.

7. Mixer according to claim 6, wherein each of these supply conduits has a curve greater than 90°, a concave surface element being inserted in correspondence thereof.

8. Mixer according to claim 7, wherein said second module includes a plurality of second inlets and a plurality of second outlets, said mixing conduits extending therebetween.

9. Mixer according to claim 8, wherein each of said second inlets is fluidically connected to the respective first outlet of said inlet conduit for the inlet of the working fluid in the respective Venturi nozzle, each of said second outlets being fluidically connected to said outlet conduit for conveying the mixed fluid.

10. Mixer according to claim 9, wherein said third module includes a third plurality of inlets and one third outlet, said outlet conduit extending therebetween.

11. Mixer according to claim 10, wherein said third inlets are fluidically connected to said second outlets, said outlet conduit including a plurality of collecting conduits fluidically connected to said third inlets to collect the mixed fluid in a single collector node fluidically connected to said third outlet.

12. Mixer according to claim 11, wherein each of said collector conduits has a substantially 90° curve.

13. Mixer according claim 1, comprising at least one supplying hose fluidically connected to the respective convergence throat of the respective Venturi nozzle and inserted in said container, said at least one supplying hose comprising at least one regulating valve for regulating the flow section thereof.

14. Mixer according to claim 13, wherein said at least one supplying hose further comprises at least one non-return valve located upstream of said regulating valve.

15. Mixer according to claim 14, wherein said at least one supplying hose is optically transparent.

16. A Venturi-effect mixer, comprising a box-like support structure with an inlet conduit for a working fluid, two or more mixing conduits connected each other in parallel for mixing the working fluid with one or more decontamination/detoxification products and an outlet conduit for the mixed fluid,
wherein each of said mixing conduits comprises a respective Venturi nozzle fluidically connected to said inlet conduit and said outlet conduit and having a convergence throat fluidically connectable to a container of the at least one decontamination/detoxification product,
wherein said box-like support structure consists of a first module which includes said inlet conduit, a second module which includes said mixing conduits and a third module which includes said outlet conduit,
wherein the mixer further comprises at least one first removable fastening element for removably connecting said second module and one of said first module and third module and at least one second removable fastening element for removably connecting said second module and the other of said first module and third module.

17. Mixer according to claim 16, wherein said first and second removable fastening elements are of the bolt type.

18. Mixer according to claim 17, wherein said first removable fastening bolt element comprises at least one first internal thread passing through said one of said first module and third module for the removable connection thereof to said second module by a corresponding first bolt, said second removable fastening bolt element comprising at least one second internal thread passing through said other of said first module and third module for the removable connection thereof to said second module by a corresponding second bolt.

19. A system, including:
a generator of a working fluid;
at least one container for at least one decontamination/detoxification product;
a jet lance for spraying the at least one decontamination/detoxification product on an area to be reclaimed;
a Venturi-effect mixer comprising a box-like support structure with an inlet conduit for a working fluid, two or more mixing conduits connected each other in parallel for mixing the working fluid with one or more decontamination/detoxification products and an outlet conduit for the mixed fluid,
wherein each of said mixing conduits comprises a respective Venturi nozzle fluidically connected to said inlet conduit and said outlet conduit and having a convergence throat fluidically connectable to a container of the at least one decontamination/detoxification product,
wherein said box-like support structure consists of a first module which includes said inlet conduit, a second module which includes said mixing conduits and a third module which includes said outlet conduit,
wherein the mixer further comprises at least one first removable fastening element for removably connecting said second module and at least one of said first module and third module,
wherein the inlet conduit of said mixer is fluidically connected to said generator, the convergence throats of the Venturi nozzles of said mixer are fluidically connected to said container and the outlet conduit of said mixer is fluidically connected to said jet lance.
